(19) United States
(12) Patent Application Publication
(10) Pub. No.: US 2006/0117116 A1
(43) Pub. Date: Jun. 1, 2006

(54) System and method for sharing MCU codes

(75) Inventor: Kuang-Liang Huang, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/288,683

(22) Filed: Nov. 28, 2005

(30) Foreign Application Priority Data
Nov. 26, 2004 (TW) 93136475

(51) Int. Cl. G06F 3/00

(52) U.S. Cl. 710/8; 715/700

(57) ABSTRACT

A system for sharing MCU (Micro Controller Unit) codes is disclosed. The system includes an LCD (Liquid Crystal Display) monitor (10). The LCD monitor (10) has an MCU (20). The MCU (20) includes a plurality of GPIO (General Purpose Input Output) pins (30), and has a plurality of function modules installed therein, which include: a dimension detecting module (201), a panel detecting module (202), and an MCU ISP (Internal System Programming) compatibility module (203).

### BACKGROUND OF THE INVENTION

1. Field of the invention

The present invention relates to a system and method for sharing MCU codes.

2. General Background

Usually, An LCD (Liquid Crystal Display) monitor has an MCU (Micro Controller Unit). The MCU is like a CPU (Central Processing Unit) or a BIOS (Basic Input Output System) of a computer. Traditionally, different LCD monitors may need different MCUs, because one kind of MCU codes corresponds to one kind of dimension and/or panel of the LCD monitors. In other cases, manufacturers must take apart the LCD monitors if they need to accomplish ISP (Internal System Programming) in different MCUs.

If the manufacturers want to improve the efficiency of producing the LCD monitors, they need to use the same MCU codes to accommodate various kinds of dimensions and panels, and enable different MCUs to accomplish ISP by using shared MCU codes.

Therefore, what is needed is a system and method for sharing MCU codes, by which different LCD monitors can share the same MCU codes.

### SUMMARY

A system for sharing MCU codes in accordance with a preferred embodiment of the present invention includes: a dimension detecting module for detecting a dimension of an LCD monitor by using shared MCU codes; a panel detecting module for detecting a panel of an LCD monitor by using the shared MCU codes; and an MCU ISP compatibility module for enabling different MCUs to accomplish ISP by using the shared MCU codes.

Further, a preferred method for detecting a dimension of an LCD monitor by using shared MCU codes includes the steps of: choosing at least one GPIO (General Purpose Input Output) pin and corresponding circuits; predefining potentials in the MCU codes; powering on the LCD monitor; detecting a potential of the chosen GPIO pins; comparing the potential with the predefined potentials in the MCU codes; and obtaining the dimension of the LCD monitor according to the comparison result.

Moreover, a preferred method for detecting a panel of an LCD monitor by using shared MCU codes includes the steps of: predefining structure files in the MCU codes according to characteristics of different panels; powering on the LCD monitor; changing setup of the panel of the LCD monitor by entering into a factory mode; and obtaining the panel's characteristics of the LCD monitor according to the predefined structure files.

Finally, a preferred method for enabling different MCUs to accomplish ISP by using shared MCU codes includes the steps of: presetting a jumping address in the MCU codes; linking ISP codes to the MCU codes orderly; and jumping to the corresponding ISP codes to execute ISP.

Other advantages and novel features of the present invention will be drawn from the following detailed description of preferred embodiments and preferred methods with the attached drawings, in which:

### BRIEF DESCRIPTION OF THE DRAWINGS

FIG. 1 is a schematic diagram of hardware configuration of a system for sharing MCU (Micro Controller Unit)codes in accordance with a preferred embodiment of the present invention;

FIG. 2 is a flowchart of a preferred method for detecting a dimension of an LCD (Liquid Crystal Display) monitor by using shared MCU codes;

FIG. 3 is a flowchart of a preferred method for detecting a panel of an LCD monitor by using shared MCU codes; and

FIG. 4 is a flowchart of a preferred method for enabling different MCUs to accomplish ISP by using shared MCU codes.

### DETAILED DESCRIPTION OF THE PREFERRED EMBODIMENTS

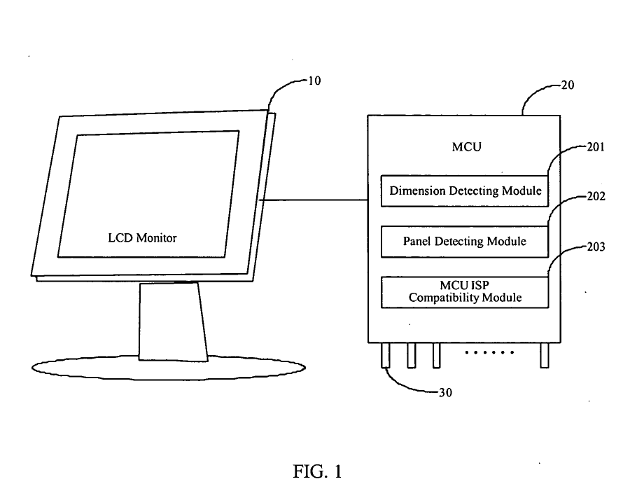

FIG. 1 is a schematic diagram of hardware configuration of a system for sharing MCU (Micro Controller Unit) codes (hereinafter, “the system”) in accordance with a preferred embodiment of the present invention. The system includes a display device like an LCD (Liquid Crystal Display) monitor 10. The LCD monitor 10 has a MCU 20. The MCU 20 includes a plurality of GPIO (General Purpose Input Output) pins 30, and has a plurality of function modules installed therein, which include a dimension detecting module 201, a panel detecting module 202, and an MCU ISP (Internal System Programming) compatibility module 203.

The dimension detecting module 201 is for detecting a dimension of an LCD monitor by using shared MCU codes. The panel detecting module 202 is for detecting a panel of an LCD monitor by using the shared MCU codes. The MCU ISP compatibility module 203 is for enabling different MCUs to accomplish ISP by using the shared MCU codes.

Therefore, a preferred method to facilitate manufacture of display devices including an LCD monitor by using shared MCU codes includes defining the shared MCU codes according to identifiable characteristics of LCD monitors to be manufactured respectively and correspondingly, installing the shared MCU codes in each of the LCD monitors to keep the shared MCU codes being retrievable therefrom, and identifying actual characteristics of each of the LCD monitor to be manufactured according to the shared MCU codes for further use. The further use includes detecting a dimension of an LCD monitor by using shared MCU codes, detecting a panel of an LCD monitor by using shared MCU codes and enabling different MCUs to accomplish ISP by using shared MCU codes.

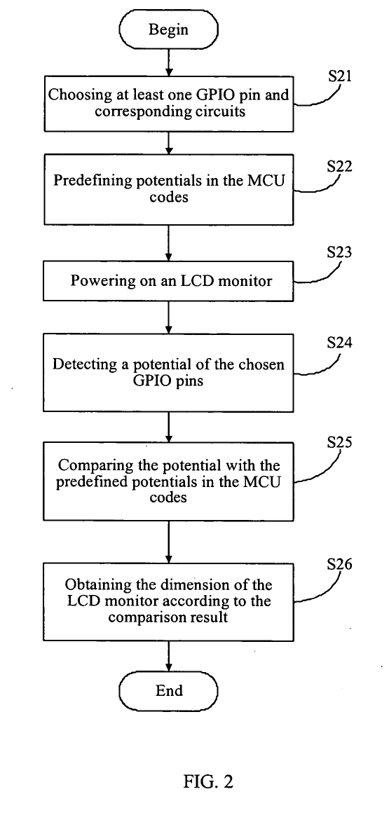

FIG. 2 is a flowchart of a preferred method for detecting a dimension of an LCD monitor by using shared MCU codes. In step S21, a user chooses at least one GPIO pin 30 and corresponding circuits. The number of the chosen GPIO pins 30 depends on the number of dimensions of different LCD monitors. Each GPIO pin 30 can match two corresponding circuits for creating a high potential and a low potential respectively, which may be expressed by “1” and “0”. Thus, two GPIO pins 30 can create four potentials which may be expressed by “00,” “01,” “10,” and “11,” and correspond to four different dimensions. In step S22, the user predefines potentials in the MCU codes. Each potential corresponds to a particular dimension of an LCD monitor. For example, supposing two GIPO pins 30 are chosen, the user can define that a potential expressed by “00” corresponds to an LCD monitor with a dimension of 14 inches, and a potential expressed by “01” corresponds to an LCD monitor with a dimension of 15 inches. In step S23, the LCD monitor 10 to be detected is powered on. In step S24, the dimension detecting module 201 detects a potential of the chosen GPIO pins 30. In step S25, the dimension detecting module 201 compares the potential with the predefined potentials in the MCU codes. In step S26, the dimension detecting module 201 obtains the dimension of the LCD monitor 10 to be detected according to the comparison result.

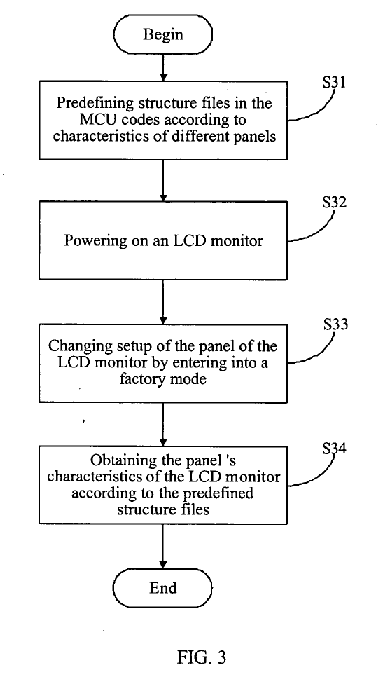

FIG. 3 is a flowchart of a preferred method for detecting a panel of an LCD monitor by using shared MCU codes. In step S31, a user predefines different structure files in the MCU codes according to characteristics of different panels. The characteristics of each panel include signals of the panel, a circuitry of the panel, and other characteristics of the panel. In step S32, the LCD monitor 10 to be detected is powered on. In step S33, the user changes setup of the panel of the LCD monitor 10 by entering into a factory mode. The factory mode can be used to maintain the LCD monitor 10 by modifying data in the memory. In step S34, the panel detecting module 202 obtains the panel's characteristics of the LCD monitor 10 to be detected according to the predefined structure files.

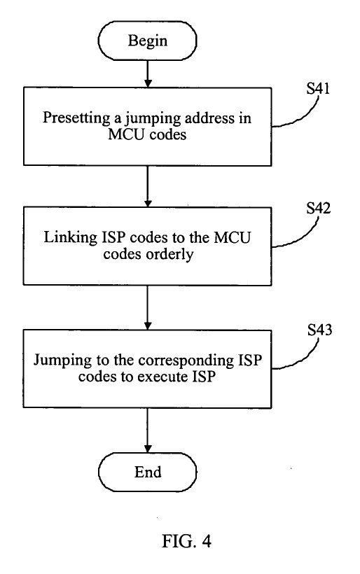

FIG. 4 is a flowchart of a preferred method for enabling different MCUs to accomplish ISP by using shared MCU codes. In step S41, a user presets a jumping address in the MCU codes according to a special constant SFR (Special Function Register), which every MCU 20 has and can be used to mark the MCU 20 uniquely. In step S42, the user links ISP codes to the MCU codes orderly. In step S43, the MCU ISP compatibility module 203 jumps to the corresponding ISP codes to execute ISP.

Although the present invention has been specifically described on the basis of preferred embodiments and preferred methods, the invention is not to be construed as being limited thereto. Various changes or modifications may be made to the embodiments and methods without departing from the scope and spirit of the invention.

We claim:

1. A system for sharing MCU (Micro Controller Unit) codes, the system comprising:
a dimension detecting module for detecting a dimension of an LCD (Liquid Crystal Display) monitor by using shared MCU codes;
a panel detecting module for detecting a panel of an LCD monitor by using the shared MCU codes; and
an MCU ISP (Internal System Programming) compatibility module for enabling different MCUs to accomplish ISP by using the shared MCU codes.

2. A method for facilitating manufacture of diverse display devices, comprising the steps of:
defining codes according to identifiable characteristics of a plurality of diverse display devices respectively and correspondingly;
installing said codes in each of said plurality of display devices so as to be retrievable therefrom; and
identifying actual characteristics of a display device to be manufactured according to said codes in order for further use.

3. The method according to claim 2, further comprising the step of detecting a dimension, as one of said actual characteristics, of said display device to be manufactured, the detecting step comprising:
choosing at least one General Purpose Input Output (GPIO) pin and corresponding circuits available in said display device;
predefining potentials in said codes;
powering on said display device;
detecting a potential of said chosen at least one GPIO pin;
comparing said potential with said predefined potentials in said codes; and
obtaining said dimension of said display device according to said comparison result.

4. The method according to claim 2, further comprising the step of detecting a panel, as one of said actual characteristics, of said display device to be manufactured, the detecting step comprising:
predefining structure files in said codes according to said identifiable characteristics of different panels;
powering on said display device;
changing setup of said panel of said display device by entering into a factory mode; and
obtaining panel characteristics of said display device according to said predefined structure files in said codes.

5. The method according to claim 2, further comprising the step of enabling said display device to be manufactured to accomplish Internal System Programming (ISP), the enabling step comprising:
presetting a jumping address in said codes;
linking ISP codes in said display device to be manufactured to said codes orderly according to said jumping address; and
jumping to corresponding ISP codes to said codes so as to execute ISP in said display device to be manufactured.

6. The method according to claim 5, wherein said jumping address is preset in said codes according to a special constant Special Function Register (SFR).

7. A method for detecting a dimension of an LCD (Liquid Crystal Display) monitor by using shared MCU (Micro Controller Unit) codes, the method comprising the steps of:
choosing at least one GPIO (General Purpose Input Output) pin and corresponding circuits;
predefining potentials in the MCU codes;
powering on the LCD monitor;
detecting a potential of the chosen GPIO pins;
comparing the potential with the predefined potentials in the MCU codes; and
obtaining the dimension of the LCD monitor according to the comparison result.

8. The method according to claim 7, wherein the number of the chosen GPIO pins depends on the number of dimensions of different LCD monitors.
